(19) United States
(12) Patent Application Publication
(10) Pub. No.: US 2026/0064638 A1
(43) Pub. Date: Mar. 5, 2026

(54) Database Control System with Machine Learning to Predict and Optimize Journal Closing and Posting

(71) Applicant: ORACLE INTERNATIONAL CORPORATION, Redwood Shores, CA (US)

(72) Inventors: John D. CLARK, JR., Pepperell, MA (US); Varghese MATHEW, Sarjapura (IN); Thomas V. LeFEBVRE, Ridgefield, CT (US); Timothy K. GAUMONT, Mesa, AZ (US)

(21) Appl. No.: 19/188,099

(22) Filed: Apr. 24, 2025

Related U.S. Application Data
(60) Provisional application No. 63/690,975, filed on Sep. 5, 2024.

(51) Int. Cl. G06F 16/18; G06F 3/04847

(52) U.S. Cl. CPC G06F 16/1815; G06F 3/04847

(57) ABSTRACT

Systems, methods, and other embodiments associated with predicting, controlling, and optimizing journal closing are described. In one embodiment, a method includes training a machine learning model based on historical journal entries, wherein the machine learning model learns combinations of features from journal entries that were approved and journal entries that were not approved. The model may evaluate a target set of journal entries using extracted features from individual journal entries. The model predicts which of the individual journal entries qualify for automatic approval by identifying combinations of the extracted features from the individual journal entries that have a multi-dimensional similarity to the learned combinations of features that were previously approved from the historical journal entries. Entries that are automatically approved may be marked with an automatically approved status and may be automatically transferred to a closing process.

### CROSS REFERENCE TO RELATED APPLICATIONS

This disclosure claims the benefit of U.S. Provisional Patent Application serial number 63/690,975 filed Sept. 5, 2024, titled “Machine Learning Model to Predict and Optimize Journal Closing and Posting”, inventors Clark Jr et al., and assigned to the present assignee, which is incorporated by reference herein in its entirety.

### BACKGROUND

In general, an electronic journal database system refers to a detailed record-keeping tool used to document all transactions of a company or an individual. An electronic journal is part of a broader accounting system and serves as the first place where transactions are recorded before they are posted to a ledger. Journals record transactions in the order they occur, which helps keep an accurate timeline of financial activities.

An electronic journal is created and maintained in database form, typically by an accounting software application. The electronic journal is a core component of accounting software applications, designed to digitally record and manage financial transactions in an organized, secure, and easily accessible format. With a graphical user interface (GUI) having interactive input fields, the software automates the process of recording debits and credits into the journal database for every transaction and integrates with other modules of the accounting system to provide a comprehensive financial management solution.

An electronic journal may be configured as one or more structured database tables within a relational database management system (RDBMS). Each table includes rows (representing records) and columns (representing fields or attributes) where each row represents an individual transaction, and each column holds specific attributes related to that transaction. The exact structure can vary depending on the software design, the complexity of the system, and the specific requirements of an organization.

In some cases, a journal might be configured and stored in a NoSQL database as documents or key-value pairs (e.g., pairs of attribute names – attribute values). This is a non-relational data structure and may be used for high-volume, real-time processing such as in large financial institutions or trading platforms. Using a NoSQL approach can provide flexibility, scalability, and faster access times to the data.

An electronic journal for an organization may have thousands or hundreds of thousands of journal entries each month. Reviewing each journal entry for approval is a time intensive and error prone process. Prior systems relied on a combination of human experience to review journal entries and a set of hardcoded programmed rules. Such programmed rules are based on numerous groups of customized Boolean filter clauses programmed as IF-THEN statements that define specified conditions and criteria.

Creating, maintaining and updating the programmed rules is a large undertaking that requires experienced programmers who understand all the programming statements and their associated programmed conditions. But they also required clear communication between many different people and departments to ensure that each filter clause is correctly programmed with the correct conditions and criteria. Any change to a rule would require re-programming the software, recompiling, retesting the code (which is repeated until accurate), and re-deploying the modified program.

It would be advantageous to have an intelligent system that could review types of data entries (e.g., journal entries) and make predictions on them, such as whether an entry met an approval threshold, without requiring specifically programmed conditions and rules.

### SUMMARY

In one embodiment, a predictor and control system may include a machine learning (ML) model and algorithm configured to determine if journal entries can be automatically approved, closed and posted without human review. For example, the ML model may be trained on historical journal entries to determine patterns of factors associated with journal entries that were approved and patterns for journal entries that were rejected. In operation, the ML model may then predict whether a particular journal can be automatically approved and closed (posted), or whether it must be reviewed and approved by a manual process. In another embodiment, the prediction or determination may be performed within a confidence band where the highest confidence journal entries are automatically approved and closed. Journal entries with lower confidence levels are not automatically approved and are instead recommended for manual review, closing and posting.

In one embodiment, a computing system with an approval prediction system is disclosed including, but not limited to, functions that: train a machine learning model based on historical journal entries, wherein the machine learning model learns combinations of features for journal entries that were approved and not approved; input a target set of journal entries into the machine learning model; evaluate, by the machine learning model, the target set of journal entries and identify combinations of features from individual journal entries that qualify for automatic approval based on the learned combinations of features that were previously approved; and mark, by the machine learning model, each of the individual journal entries that are automatically approved.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a predictor system associated with training a machine learning model for predicting automatic approvals of journal entries for transactions.

FIG. 2 illustrates another embodiment of the predictor system in operation for predicting automatically approved journal entries.

FIG. 3 illustrates one embodiment of a method associated with predicting automatic approvals of journal entries and controlling a workflow.

FIG. 4 illustrates an embodiment of a computing system configured with the example systems and/or methods disclosed.

### DETAILED DESCRIPTION

Systems and methods are described herein that provide a predictor and control system with machine learning to predict and optimize journal closing and posting processes. The predictor and control system may include one or more machine learning models trained and configured to predict/determine whether journal entries may be automatically approved/closed and posted. By automatically approving journal entries, the present system controls and changes the processing functions for those journal entries by automatically transferring them from a journal data table to a general ledger database. Thus, processing steps for those journal entries modified to have fewer actions, thereby reducing and/or eliminating previously performed actions. As such, the present prediction and control system may reduce the total processing time of journal entries and optimize the journal closing and posting process.

For example, when journal entry is approved to be transferred to the general ledger, it typically means that the transaction recorded in the journal entry has been reviewed, verified, and deemed accurate and thus valid. The journal entry may then be posted to the general ledger, which is a permanent record of a company’s financial transactions.

With the present system, when a journal entry is automatically approved, it means the system automatically predicts the entry to be valid. As such, the initial steps of being reviewed and verified for accuracy in prior techniques are eliminated for that entry. For an organization that has thousands or millions of transactions per month that are reviewed, the present automatic approval technique saves large amounts of time and resources even when a small percentage of the total transactions are automatically approved.

Furthermore, since the present system uses a machine learning model trained to predict approvals based on journal entry patterns, the present system is dynamic and adaptive to data. Thus, it reduces and/or eliminates the dependency on hardcoded programmed rules that use numerous groups of customized Boolean filter clauses programmed as IF-THEN statements that define specific conditions and criteria. As such, the present system improves upon previous hardcoded techniques that needed to be manually reprogrammed any time a condition changed.

### ML Model Creation

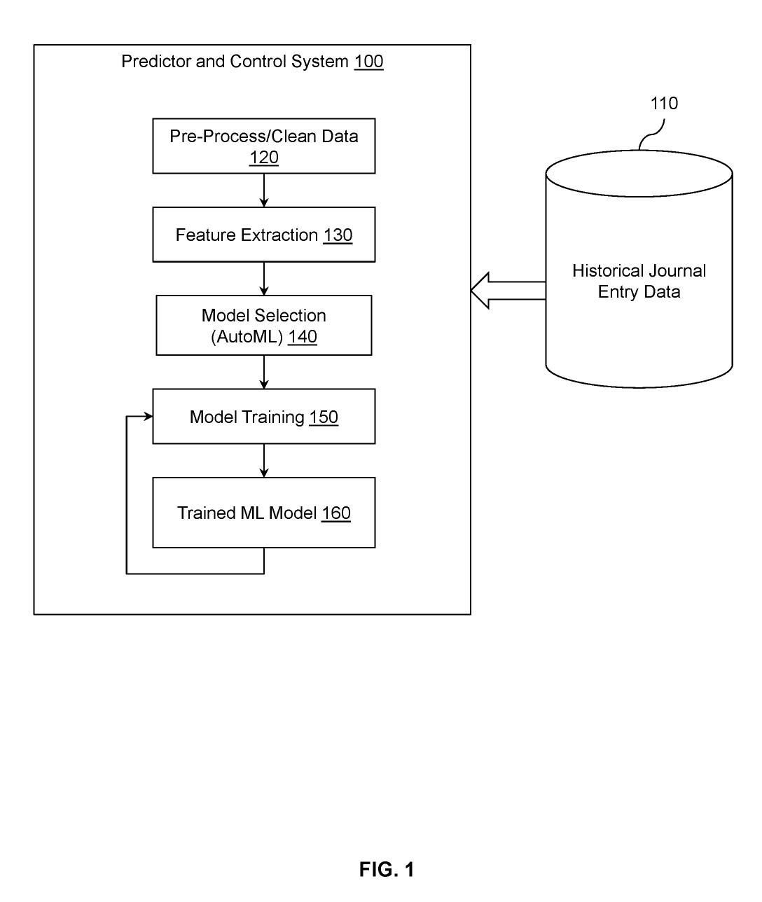

With reference to FIG. 1, one embodiment of a predictor and control system 100 (also referred to as predictor system 100) is illustrated that is associated with creating and training a machine learning (ML) model 105 to predict whether a journal entry may be automatically approved based on the attributes of the journal entry.

As previously stated, an electronic journal may be configured as one or more structured database tables. The database tables may include rows of data where a single row represents one journal entry associated with one transaction, and columns represent fields or attribute values contained in the journal entry of an individual transaction. As such, a journal entry in the database is a transaction object and/or a transaction data record.

An organization may have many different accounts whose transactions are tracked in an electronic journal. Banks and other financial institutions often process millions of transactions across many customer accounts. Thus, their journal entries may capture both financial system-level information and customer-level detail (e.g., transaction objects in transaction logs).

Example attributes recorded in a journal entry that represents a transaction may include, but are not limited to, Journal entry ID and/or Transaction ID, Posting Date, Customer ID or Account number, Transaction Type (e.g., (e.g., deposit, withdrawal, interest payment, loan disbursement, etc.), Account Debited, Account Credited, Debit Amount, Credit Amount, Description or explanation of the entry, Currency, Exchange Rate, Account Risk Level, Reference Number, Cost Center or business segment, Tax Information, Prepared/Created By (e.g., User ID that created the entry), Audit Trail Information, Attachments or Supporting Documents, Period or Fiscal Period, Location or Branch Code, Project Code, Journal Entry Number, Reversal Indicator, and/or Transaction Tags or Labels. In one embodiment, the attributes may be regarded as metadata for a transaction.

A journal entry may also contain attributes identifying an approval status of the entry, for example, but not limited to: Approval Status (e.g., approved, rejected, canceled, pending, or other values.), Approved By (e.g., User ID who approved the entry), Rejected By (e.g., User ID who rejected the entry to a general ledger), and a Timestamp of approval or rejection.

Combinations of the above attributes, or other desired attributes may be used as selected features for training the ML model as discussed below.

### ML Model Training and Feature Selection

With continued reference to FIG. 1, in one embodiment, the present predictor and control system 100 may be configured to build a machine learning (ML) model that is trained to predict whether a journal entry can be automatically approved and automatically posted to a general ledger database. The ML model is initially trained using a set of historical journal entries 110 taken from prior months or years of journal data.

At block 120, in one embodiment, the historical journal entries 110 may be initially pre-processed to understand its structure, schema, including column names, data types, and the nature of each attribute/variable. The raw historical data may be cleaned in a variety of ways, for example but not limited to, handling missing values, scaling values, encoding into numerical values, etc. In one embodiment, text or string values may be encoded into numeric values, and numeric values may be scaled to ensure they are on a similar scale.

At block 130, a feature selection process may be performed to identify and extract relevant attributes from the historical journal entries 110 to generate feature vectors. Relevant features selected may include some set of attributes or all of the attributes contained in the data tables of the journal entries. A feature vector may be a 1-dimensional array of numerical values that represent one journal entry transaction, in one embodiment. The feature vectors are used to train an ML model.

In general, creating the feature vectors converts the raw data of the historical journal entries 110 into a standard format so that all the data has the same uniform data structure and types of values. Different historical journal entries may have different attributes, different formats, and/or attribute values. The ML model expects a consistent input structure to correctly learn and apply patterns across the input data. If the feature vectors had different formats, different amounts of attributes, and/or different orders of attributes, the ML model may not be able to interpret the data correctly and may learn incorrect associations. Thus, the raw data is transformed into feature vectors that have a uniform, consistent length and data structure.

In one embodiment, a user interface may be provided to allow a user/customer to select a set of journal entry attributes to use as features for training the ML model. For example, based on the data structure of a journal entry used by a particular customer, available attributes may be provided as selectable options or a selectable list on a display of a computing device. Customer selection of attributes allows the attributes/features that go into training the ML model prediction to change customer-by-customer to generate a customized model. This provides greater flexibility and customization over fixed ML systems that define a set of default features for every customer.

At block 140, an ML model may be selected for training from a set of available ML model types. In one embodiment, an automatic machine learning process (e.g., AutoML) may be implemented as described below.

At block 150, the present predictor system 100 may train the ML model and algorithm using the selected features (e.g., training dataset) to identify patterns of features from journal entries that were approved and identify patterns of features that were not approved or otherwise were rejected. For example, each historical journal entry may contain an attribute relating to an “Approval Status” that indicates whether that journal entry was approved or not. With this value, the ML model may learn and associate patterns of attributes from the journal entries that were actually approved. Likewise, the ML model may learn and associate patterns of attributes from the journal entries that were not approved, rejected, and/or that had a different approval status. These become internalized patterns of the trained ML model 160.

After training, the ML model 160 contains internalized patterns from the historical journal entry data, where the ML model has learned what feature combinations in a journal entry typically correspond to particular outcomes (e.g., approved, rejected, other, etc.). The internalized patterns are captured as learned parameters during training and these parameters encode the relationships between features of transactions from journal entries and their outcomes (e.g., approved, not approved).

In one embodiment, the ML model 160 may learn the patterns and combinations of features where the historical journal entries were approved based on the approved status attribute, which is one value in the pattern. The ML model 160 may also learn the combination of features that are associated with initially rejected journal entries (or otherwise not automatically approved). The ML model may be trained to recognize patterns and relationships between the journal entry features that are associated with approved entries and not approved entries. Thus, the ML model 160 may be trained to analyze these different data points and figure out, within different combinations of attributes in the journal entries, which combinations/patterns were approved every time, which combinations were approved some percentage of the time, and which combinations were never approved.

In one embodiment, an approval confidence level may be determined for different combinations of journal entry attributes. The approval confidence level may be used as a threshold level to designate whether a journal entry is automatically approved or not approved. For example, the approval confidence level may come from the model’s internal probabilities. For example, the internal probabilities may be the output of a logistic regression or neural network layer. If the model includes a binary classifier, it may calculate a probability such as 0.92 for automatic approval of a particular journal entry and use that as the confidence level.

In general, journal entries usually follow a pattern and when they don't, they have similar metadata/attributes about the transaction itself. Some customer accounts within a transaction system may be identified as low risk while other accounts may be identified as high risk. These risk values may be stored as attribute values within journal entry transactions and may be a factor in the approval or non-approval (rejection) of a transaction. For example, a low dollar amount (e.g., $100) involved in a historical journal entry transaction for a customer account may be associated with an automatic approval unless other attribute patterns are seen that show that same customer account number has a large volume of transactions going in and out of the account number. That overall scenario makes the transactions unusual for a single account number and thus may be the main reason those journal entries were not approved (rejected). The ML model may learn this combination of features from the historical data and associate the outcome of “not automatically approved” (e.g., rejected) to that combination of features.

In another example from the historical data of journal entries, the ML model 160 may determine that in the ABC account segment that has under a $100000 balance, the journal entries were automatically approved every time. Likewise, from the historical data of journal entries, the ML model 160 may determine that journal entries from the XYZ account segment that are under $150000 were approved automatically. Thus, these types of combinations and patterns of attributes are learned and associated with a predicted outcome of “automatically approved.”

Based on the learned patterns, the ML model 160 may predict an outcome for a new journal entry. When the ML model 160 evaluates a new journal entry transaction that has similar traits (similar combination of features) to learned patterns that were not automatically approved, the ML model 160 will likely not automatically approve the new journal entry even if the customer account number is not marked as a high risk account (e.g., account numbers are different between the new entry and the historical high risk entries). That’s because the overall pattern is similar to what was learned, and the account number is only one piece of the pattern. This is another way that the present prediction system improves upon prior techniques that use specific conditions in hardcoded IF-THEN statements.

In this manner, the ML model 160 is training on what's been automatically approved in the past, where the historical data identifies what entries have been automatically approved and what entries have been manually approved (and thus not automatically approved). If there are 100000 journal entries and 80,000 of them were automatically approved, the ML model 160 determines the common factors and common combinations of features. It may have been the account balance involved, or the account segment involved, but typically it is a combination of factors, conditions and values that make a journal entry eligible for automatic approval.

In one embodiment, the trained ML model 160 may be tested and evaluated. For example, the ML model 160 may be trained on historical journal entries from the last two years but excluding data from the month of January. The journal entries from January may be input to the ML model 160 and evaluated to predict which entries are automatically approved and which are not approved. The predictions may then be compared to the actual approval results from the January journal entries to generate a confidence level for the approval predictions. Results may also be fed back into the ML model to make adjustments to the algorithm.

After training, the ML model 160 may contain thousands or millions of learned parameters that are part of the internalized patterns learned. These represent nonlinear patterns and multi-dimensional relationships between features that were learned from historical journal entry data. In one embodiment, the learned parameters define boundaries, surfaces, or manifolds in a multi-dimensional space that separate different outcomes. For example, for predicting automatic approval of journal entries, the model might map known “approved” transactions (e.g., feature vectors) to specific subregions of the multi-dimensional space and map non-approved transactions to other regions in the multi-dimensional space. With this configuration, new input vectors from new journal entries are evaluated by checking where the input vectors fall in the multi-dimensional space. In one embodiment, the multi-dimensional space is referred to as a high-dimensional space when it has five or more dimensions.

The ML model 160 uses the internalized, high-dimensional patterns learned from vast historical journal data, applies transformations to new journal data, and makes decisions based on multi-dimensional similarity, for example. Multi-dimensional similarity refers to how similar or close two data points (e.g., two feature vectors) are when measured in a space with multiple features (multiple dimensions). This process is far too complex and fast to be replicated manually or mentally by a human for at least the reason that humans cannot operate with or process data with even 5-dimensions from thousands of transactions, let alone with dozens or hundreds of dimensions.

In one embodiment, the learned internalized patterns may be stored memory, in RAM, on a solid-state device, and/or GPU memory. In other embodiments, Programmable Logic Devices (PLDs) such as Field Programmable Gate Arrays (FPGAs) can be used to implement the patterns and/or neural networks of the ML model directly in hardware. The weights and structure of the ML model may be converted into logic gates or embedded RAM blocks.

In one embodiment, the ML model 160 may be tuned based on new journal entry data. This provides feedback to the ML model 160 and updates it parameters. Tuning may be performed on a periodic basis. For example, the ML model 160 may be tuned based on new feedback data by retraining or fine-tuning the model with updated examples that include corrected labels or corrected outcomes for automatic approval. This feedback helps the ML model 160 learn from recent mistakes and/or adapt to changing patterns in the data. The retraining/retuning process may involve adjusting model parameters, updating hyperparameters, or incorporating online learning, where the ML model 160 incrementally learns from each new data point. The tuning improves the ML model’s accuracy and relevance over time.

### Selection of ML Model Embodiment

In one embodiment of block 140 in FIG. 1, a particular ML model may be selected for training from an available set of algorithms (e.g., Random Forest, XGBoost, Neural Nets, etc.) by a user interface selection. The selected model may be trained as described above.

In another embodiment, an automated machine learning (AutoML) process may be implemented that identifies and selects an optimal ML model for the type of training data and objective from multiple available ML models. For example, AutoML may be used to automate the end-to-end tasks of applying machine learning to the historical journal entry data. The AutoML process may include selecting the best ML model for the historical data from multiple available ML models. For example, AutoML automatically searches, builds/trains, and evaluates different ML model algorithms and hyperparameters based on the historical journal entry data. AutoML compares results of the different ML models and identifies a high-performing model with a high degree of accuracy. In this case, the accuracy relates to accurately predicting which journal entries should be automatically approved based on the pattern of attributes contained in the journal entries.

For example, the AutoML is given a set of historical journal entries and is asked to predict which entries are approved and/or which are rejected. The AutoML process may automatically perform the following functions. It may clean and preprocess the data (e.g., handling missing values, scaling the data, encoding into numerical values, etc.). Relevant features may be selected and extracted from the journal entry data structure (e.g., feature engineering and reduction), which creates feature vectors. A feature vector may be a 1-dimensional array of numerical values, in one embodiment.

Using the feature vectors as input, multiple types of models (e.g., Random Forest, XGBoost, Neural Nets, etc.) may be trained and tested. For each model, AutoML may tune hyperparameters using optimization techniques (e.g., grid search, Bayesian optimization, etc.). Each trained model is tested and evaluated for performance using metrics (e.g., accuracy, AUC, F1-score, etc.). The testing may be based on inputting a test set of historical journal entries that the ML model was not trained with to measure accuracy in the predictions as compared to the actual results for each historical journal entry (e.g., approved or not approved). The best-performing model may then be selected based on the objective to accurately predict which journal entries should be automatically approved. The selected trained ML model 160 may then be deployed or exported for production.

In one embodiment, the ML model 160 may be tuned based on new journal entry data. This provides feedback to the ML model 160 and updates it parameters. Tuning may be performed on a periodic basis.

### Example Operation and Prediction of Approved Journal Entries

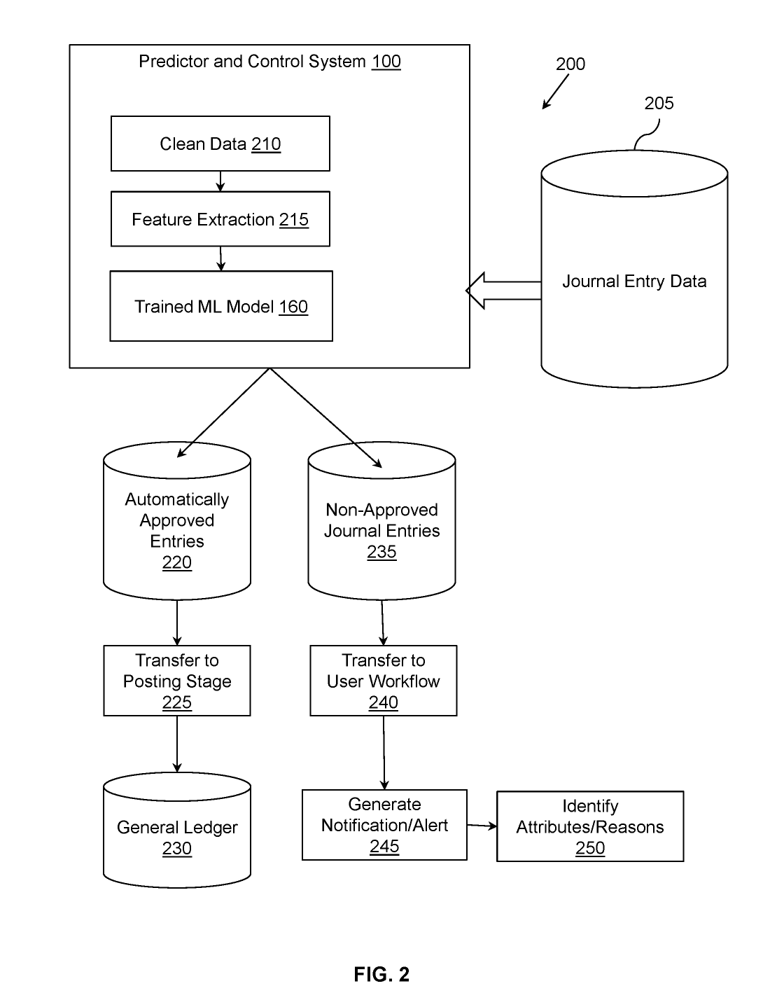

With reference to FIG. 2, one embodiment of a prediction technique 200 is illustrated that may be associated with the predictor system 100 and ML model 160 discussed in FIG. 1, in one embodiment. The illustrated blocks are used to simplify the descriptions and may represent configured functionality and/or processes performed by the system 100.

For example, in operation, the ML model 160 may be used to evaluate new journal entries (a target data set) to identify which journal transactions are predicted as automatically approved. For those that are automatically approved, the processing workflow is modified by automatically transferring the approved entries to a general ledger database. Thus, the automatically approved entries bypass additional review processes which take more time, thereby reducing the overall set of data subjected to a review process.

For example, an input set of new journal entries 205 may be identified and submitted to the present predictor system 100. The raw data may be pre-processed and cleaned at block 210, in the same manner as the training data was preprocessed and cleaned in block 120 (FIG. 1).

At block 215, features are extracted from the new journal entries in the same or similar manner as were the features extracted from the historical journal entries used for training the ML model (see FIG. 1, block 130). The ML model 160 may evaluate the extracted features from each new journal entry and determine whether the journal entry qualifies for automatic approval or not (rejected) based on the learned patterns of features that were known to be approved from the training data. In one embodiment, a defined confidence level may be set as a threshold for determining whether an entry is automatically approved.

In one embodiment, the evaluation process performed by the ML model 160 may include the following actions, which cannot be performed manually or mentally for the reasons below. For each target journal entry being evaluated from the input journal entry data 205, features are extracted from the target journal entry and are converted into a numerical feature vector that has a standard format and standard structure across all feature vectors, as previously described during training. The standard format and structure should match the format of the training set of feature vectors so that input vectors are consistent and are as expected by the ML model 160. Otherwise, the ML model 160 may not properly understand and interpret the input data.

Even a simple journal entry transaction may contain dozens or hundreds of numerical features, resulting in a feature vector array with hundreds of dimensions. The feature vector is fed into the trained ML model 160. As stated previously, the ML model 160 may contain thousands or millions of learned parameters. The patterns represent nonlinear patterns and multi-dimensional relationships between features that were learned from the historical journey entry data, creating a multi-dimensional (high-dimensional) feature space.

In one embodiment, the ML model 160 may perform matrix multiplications, nonlinear activations, layer-by-layer transformations, or tree-based splits based on the type of ML model. The input feature vector may be transformed into the multi-dimensional feature space of the learned internalized patterns. These transformations are not visible or understandable in a human sense. The transformed input feature vector is positioned as a data point in the high-dimensional feature space of the ML model, which allows for pattern matching in the high-dimensional feature space. This provides a more dynamic and flexible prediction system that is an improvement over prior hardcoded techniques that rely on specific condition filtering rules (e.g., IF-THEN programming code).

From one viewpoint, the ML model 160 evaluates the position of the input feature vector in the high-dimensional feature space and decides, for example, "how close is this position to the regions that have been learned to represent automatic approval (or not automatic approval)?" In simple terms as previously explained, in one embodiment, the trained ML model 160 may have created the multi-dimensional space of feature vectors, where known “approved” transactions (e.g., approved feature vectors) are mapped to specific subregions of the multi-dimensional space. Known non-approved transactions (non-approved feature vectors) are mapped to other regions in the multi-dimensional space. With this configuration, new input vectors from new journal entries 205 are evaluated by checking where the input vectors fall in the multi-dimensional space.

This decision is happening in a space with dozens or hundreds of dimensions, which is far beyond human visualization, understanding, or manual comparison. There are too many features and dimensions for the human brain to process and make a decision based on multi-dimensional similarity. There are hidden patterns learned from millions of examples that a human cannot visualize mentally or reproduce on paper. The nonlinear combinations, weights, and activations of the internalized patterns are very complex. There is no way for humans to mentally visualize data in dozens or hundreds of dimensions to perform the predication as the present ML model 160 is performing.

An output of the ML model may be a prediction, a probability, or both. For example, for the evaluated journal entry, the ML model 160 may return a prediction decision (e.g., “automatically approved”) and/or with a confidence score (e.g., 93% chance of automatic approval). For example, the decision may be determined based on how/where the feature vector of the evaluated journal entry is positioned in the internalized patterns of the multi-dimensional space.

In one embodiment, for each new journal entry that the ML model 160 predicts should be automatically approved, the ML model 160 may mark the journal entry as approved. This may include setting a flag, and/or inserting an approved status in the journal entry data record itself that indicates automatic approval. For example, the approval flag/status may be inserted into a data row representing the journal entry and in a column in the associated journal data table.

Upon completion of the evaluation, the predictor system 100 may initiate alternative control over a posting process. For example, the journal entry data table 205 may be searched for journal entries that were automatically approved. The automatically approved entries may be transferred (e.g., copies of entries) from their source database (e.g., a journal entry database) to an approved database 220, which contains the automatically approved journal entries. The database 220 may include the general ledger database, in one embodiment.

In another embodiment, the automatically approved journal entries may be copied and transferred from their source database in real-time by the predictor system 100 upon being evaluated by the ML model 160. The approved entries may then be automatically transferred (block 225) to a posting stage or directly to the approved database 220 that stores the automatically approved journal entries.

At block 225, the automatically approved entries from the approved database 220 may then be automatically transmitted to the next stage in the workflow (e.g., to a posting stage or directly to a general ledger database 230). Since these entries are automatically approved, they are not transferred to a user for manual review. Additional review steps or actions are not necessary and are eliminated for the automatically approved entries. In one embodiment, the posting stage may be an in-memory queue or data table(s) for storing the approved entries. Logic may be applied to the approved entries to prepare them for final transfer to the general ledger database 230.

Journal entries that are not automatically approved by the ML model 16 (e.g., do not contain the approved status) may be transferred to a non-approved database 235. At block 240, the prediction system 100 may then transfer the journal entries that do not have the approved status to a workflow assigned to a user. This may further trigger the system to generate a notification/alert to the user (at block 245) in real-time or near real-time, where the alert indicates there are journal entries waiting for review. The notification/alert may also be configured to provide an access link where the user may access the journal entries in the non-approved database 235.

In another embodiment, the ML model 160 may output reasons why an entry was not approved, based on for example, the pattern similarities. Thus, the notification/alert may also identify the journal entry attributes and/or associated reasons for why the journal entry was not automatically approved by the ML model 160. This may be used in the future for someone that, during the preparation stage of the journal entry, could make adjustments to the journal data so the entry may better qualify for automatic approval the next time it is submitted.

In prior systems, an alert notification that requested review was generated and transmitted to one or more users for every journal entry prior to being transferred into a general ledger database. The prior technique consumed much more processing resources than the present auto approval prediction system 100 by consuming network bandwidth with thousands or tens of thousands of messages on a monthly basis to multiple users. With the present auto approval system 100, alert notifications for approved entries are eliminated and the processing steps previously performed are skipped. Thus, processing resources and network bandwidth are reduced, improving the performance of the computing system overall.

In another embodiment, multiple evaluation runs may be executed on the new journal entries 205. For example, during the first run, the confidence level for approval may be set at a medium level (e.g., 80% approval confidence). Then only journal entries with feature patterns that were historically approved above the threshold would be approved. The approval prediction may then be re-executed on the initially approved journal entries with a higher confidence level to identify those entries that would pass a second level of approval review for organizations that had multi-level approval processes.

In general, using the historical journal data, the ML model 160 may consider many different data points and combination of variables/factors from historical journal entries to automatically approve qualified new entries and avoid manual review steps. For a customer who has potentially hundreds of thousands of journals entries every month, being able to identify the entries that do not need a manual review may greatly reduce the overall processing time of journal entries and improve system performance for posting journal entries to a general ledger.

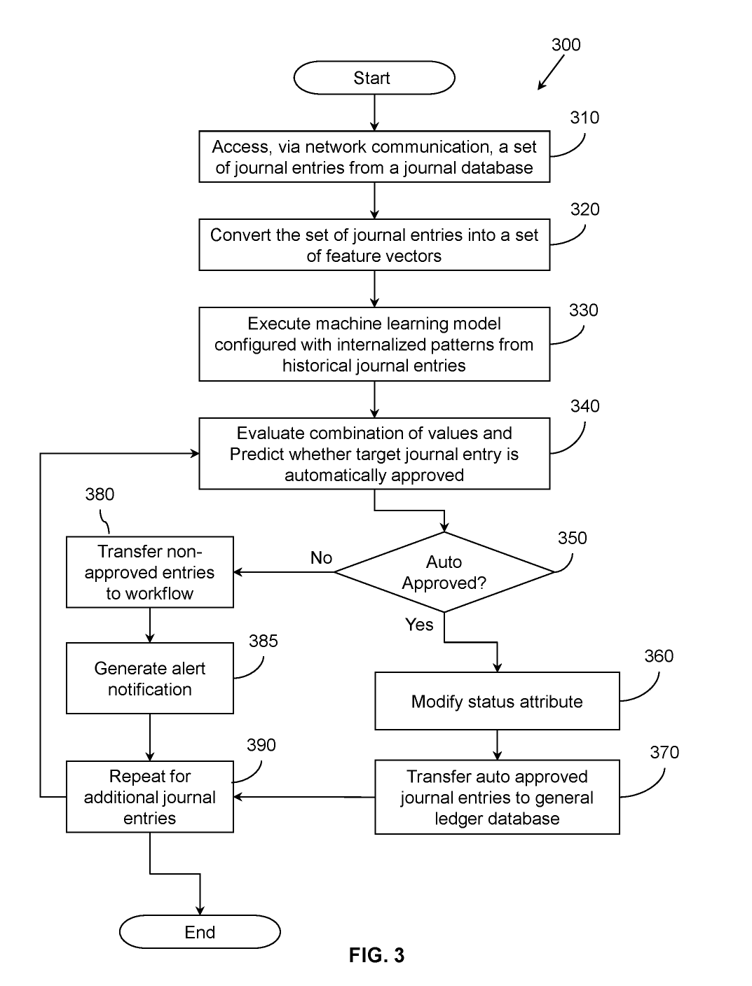

With reference to FIG. 3, one embodiment of a method 300 is illustrated that is associated with the predictor and control system 100 shown in FIG. 1 or FIG. 2. Method 300 may be implemented to automatically process journal entry data records and predict which entries are automatically approved. Method 300 may then control a process flow of the journal entries between different computing systems and/or different databases based on whether they are automatically approved or not approved. Method 300 is described from the perspective of the predictor system 100 having an ML model already trained and deployed for operation, for example, ML model 160 (see FIGS. 1 or 2). The ML model will be used to evaluate a set of journal entries during a closing process.

At block 310, the set of journal entries are accessed, via network communication, from a journal database that contains the journal entries. As previously explained, each journal entry is a data structure including a plurality of attributes associated with a transaction represented by the journal entry. The access may include submitting a query from the predictor system 100 to the journal database and retrieving the requested journal entries. In another embodiment, the access may include receiving the set of journal entries as input data into the predictor system 100.

At block 320, the set of journal entries may be converted into a set of feature vectors, wherein each feature vector corresponds to a particular journal entry and includes a combination of values representing the transaction of the particular journal entry. As explained previously, for each target journal entry being evaluated, features are extracted from the target journal entry and are converted into a numerical feature vector. The feature vector has a standard format and standard structure so that the feature vectors are uniform and match the format of the feature vectors used to train the ML model. The conversion process may also include preprocessing and cleaning the data as previously explained, in one embodiment (e.g., FIG. 2 blocks 210, 215).

At block 330, the ML model may be executed and the set of feature vectors are received as input feature vectors. In one embodiment as previously explained (see FIG. 1), after training, the machine learning model is configured with internalized patterns in a multi-dimensional space that are learned from multi-dimensional combinations of features from a set of historical journal entries including transactions that are known to be approved and transactions that are known to be not approved.

At block 340, the ML model evaluates the combination of values from each input feature vector corresponding to a target journal entry from the set of journal entries based on at least the internalized patterns. Method 300 may be configured to process and evaluate individual journal entries and their feature vectors in a series and/or may process groups of entries concurrently. The evaluation may include applying the target feature vector into the internalized patterns stored in memory. As previously explained, this may include positioning the target feature vector as a data point in the high-dimensional feature space of the ML model, which allows for pattern matching in the high-dimensional feature space.

The ML model predicts whether the target journal entry is automatically approved for transfer to a general ledger database based on at least the combination of values from the corresponding input feature vector (e.g., position in the feature space). The prediction is based on the feature vector having a multi-dimensional similarity, within a threshold, to a pattern of values learned from the historical journal entries that were approved, as learned by the ML model.

At block 350, the method determines whether the target journal entry is automatically approved by the ML model or not approved. This is determined from the output of the ML model. Based on whether the targe journal entry is approved, the predictor system 100 changes control of the processing steps. For example, when approved, the method goes to block 360, which is an optimized technique for automatically posting and closing journal entries.

At block 360, a status attribute in the target journal entry may be modified in the journal database to represent an approved status. For example, the journal entries may include an attribute field representing an Approval Status or similar field. An approval status value may be inserted into the data record of the journal entry to represent that the journal entry has been “automatically approved” and/or marked as approved with a status flag. This modification is performed for each target journal entry that is predicted as automatically approved.

At block 370, the target journal entries that have the approved status may be transferred into a general ledger database. This may be performed as a journal entry is predicted as approved and/or may be performed upon completing the evaluation of the set of journal entries.

In one embodiment, the approved entries may be transferred to a closing or posting stage to process the entries if a particular system has additional functions to perform on the entries prior to being transferred and stored in the general ledger database.

At block 390, the method may check for additional journal entries to be evaluated, and the process is repeated. Otherwise, the process may end.

Referring back to block 350, for target journal entries that are not automatically approved (e.g., entries that do not have the approved status or are not marked as approved), the method transfers the entries to a workflow assigned to a user (block 380). This may include transferring the entries and populating a dashboard assigned to one or more users, where the dashboard identifies the journal entries that are waiting for review and approval.

At block 385, an alert notification may be generated and transmitted to the one or more users. The alert may identify the journal entries in the workflow and provide a reminder to access the target journal entries in the workflow. In one embodiment, the alert notification may include a link to directly access the dashboard and/or or a user interface that initiates the review of the non-approved journal entries.

In another embodiment, the ML model 160 may output reasons why an entry was not approved, based on for example, the pattern similarities. Thus, the alert notification may also identify the journal entry attributes and/or associated reasons for why the journal entry was not automatically approved.

At block 390, the method may check for additional journal entries to be evaluated, and the process is repeated. Otherwise, the process may end.

In another embodiment, method 300 may be configured to execute multiple evaluation runs on the set of journal entries being evaluated. For example, during a first run, a confidence level for automatic approval may be set at a medium level (e.g., 80% approval confidence). Then only journal entries with feature vectors with patterns of attributes that were historically approved above the threshold are automatically approved.

During a second run, the confidence level is increased (e.g., 90% approval confidence) and the approval prediction may then be re-executed on the initially approved journal entries. With the higher confidence level, the predictor system 100 attempts to identify journal entries that would pass a second level of approval review for organizations that have multi-level approval processes. In one embodiment, the automatically approved journal entries that pass and/or satisfy the different confidence levels of approval may be identified and separated for additional processing. For example, the entries that satisfy the highest confidence level may be automatically transferred to the general ledger database as previously described.

Accordingly, the present predictor and control system 100 and techniques for automatically approving journal entries provide improved processing techniques where automatically approved journal entries may be automatically transferred from a journal data table to a general ledger database. Thus, processing steps for those journal entries may be reduced or eliminated, which in turn reduce the total processing time of journal entries and optimizing the journal closing and posting process as compared to prior systems and techniques.

Prior systems relied on a combination of human experience to review journal entries and a set of hardcoded programmed rules. Such programmed rules are based on numerous groups of customized Boolean filter clauses programmed as IF-THEN statements that define specified conditions and criteria. The present system improves upon these hardcoded techniques for the reasons explained herein. Furthermore, the present system reduces the amount of alert notifications that are generated and transmitted in a computing or database system as compared to prior techniques.

### Cloud or Enterprise Embodiments

In one embodiment, the present journal entry approval predication system 100 may be a computing/data processing system including an application or collection of distributed applications for enterprise organizations. The computing system may include one or more computing devices operably connected to communicate over one or more communication networks via one or more network interfaces. The applications and computing system may be configured to operate with or be implemented as a cloud-based networking system, a software as a service (SaaS) architecture, or other type of networked computing solution. In one embodiment, the present system may be a centralized server-side application that provides at least the functions disclosed herein and that is accessed by many users via computing devices/terminals communicating with the computing system (functioning as the server) over a computer network.

In one embodiment, one or more of the components described herein are configured as program modules stored in a non-transitory computer readable medium. The program modules are configured with stored instructions that when executed by at least a processor cause the computing device to perform the corresponding function(s) as described herein.

In one embodiment, one or more of the components described herein are configured as program modules stored in a non-transitory computer readable medium. The program modules are configured with stored instructions that when executed by at least a processor cause the computing device to perform the corresponding function(s) as described herein.

### Computing Device Embodiment

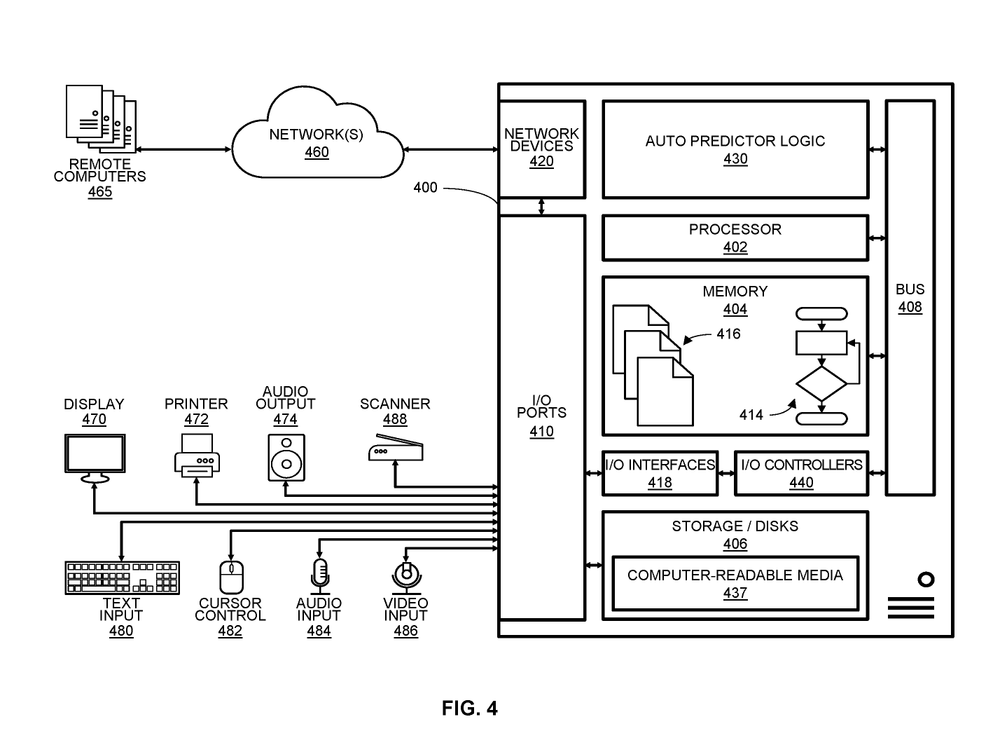

FIG. 4 illustrates an example computing device that is configured and/or programmed as a special purpose computing device with one or more of the example systems and methods described herein, and/or equivalents. The example computing device may be a computer 400 that includes at least one hardware processor 402, a memory 404, and input/output ports 410 operably connected by a bus 408. In one example, the computer 400 may include auto predictor logic 430 configured to facilitate automatic approval of journal entries similar to predictor system 100 shown in FIGS. 1, 2, and 3. The computing device may be part of multiple computing devices in a computing system.

In different examples, the logic 430 may be implemented in hardware, a non-transitory computer-readable medium 437 with stored instructions, firmware, and/or combinations thereof. While the logic 430 is illustrated as a hardware component attached to the bus 408, it is to be appreciated that in other embodiments, the logic 430 could be implemented in the processor 402, stored in memory 404, or stored in disk 406.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to XXX. The means may also be implemented as stored computer executable instructions that are presented to computer 400 as data 416 that are temporarily stored in memory 404 and then executed by processor 402.

Logic 430 may also provide means (e.g., hardware, non-transitory computer-readable medium that stores executable instructions, firmware) for performing one or more of the disclosed functions and/or combinations of the functions.

Generally describing an example configuration of the computer 400, the processor 402 may be a variety of various processors including dual microprocessor and other multi-processor architectures. A memory 404 may include volatile memory and/or non-volatile memory. Non-volatile memory may include, for example, ROM, PROM, and so on. Volatile memory may include, for example, RAM, SRAM, DRAM, and so on.

A storage disk 406 may be operably connected to the computer 400 via, for example, an input/output (I/O) interface (e.g., card, device) 418 and an input/output port 410 that are controlled by at least an input/output (I/O) controller 440. The disk 406 may be, for example, a magnetic disk drive, a solid state disk drive, a floppy disk drive, a tape drive, a Zip drive, a flash memory card, a memory stick, and so on. Furthermore, the disk 406 may be a CD-ROM drive, a CD-R drive, a CD-RW drive, a DVD ROM, and so on. The memory 404 can store a process 414 and/or a data 416, for example. The disk 406 and/or the memory 404 can store an operating system that controls and allocates resources of the computer 400.

The computer 400 may interact with, control, and/or be controlled by input/output (I/O) devices via the input/output (I/O) controller 440, the I/O interfaces 418, and the input/output ports 410. Input/output devices may include, for example, one or more displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 406, network devices 420, and so on. The input/output ports 410 may include, for example, serial ports, parallel ports, and USB ports.

The computer 400 can operate in a network environment and thus may be connected to the network devices 420 via the I/O interfaces 418, and/or the I/O ports 410. Through the network devices 420, the computer 400 may interact with a network 460. Through the network, the computer 400 may be logically connected to remote computers 465. Networks with which the computer 400 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, any illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established (or may be established upon request) that allow signals, data, messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When intended to indicate “only A or B but not both” then the phrase “only A or B but not both” will be used. Thus, use of the term “or” herein is the inclusive, and not the exclusive use.

What is claimed is:

1. A computing system comprising:
one or more computing devices operably connected to communicate over one or more communication networks via one or more network interfaces;
at least one processor connected to at least one memory, wherein the at least one processor is operably connected to at least one of the one or more computing devices; and
a non-transitory computer readable medium including instructions stored thereon that when executed by at least the processor cause the computing system to:
access, via network communication, a set of journal entries from a journal database, wherein each journal entry is a data structure including a plurality of attributes associated with a transaction represented by the journal entry;
convert the set of journal entries into a set of feature vectors, wherein each feature vector corresponds to a given journal entry and includes a combination of values representing the transaction of the given journal entry;
execute a machine learning model and receive the set of feature vectors as input feature vectors, wherein the machine learning model is configured with internalized patterns in a multi-dimensional space that are learned from multi-dimensional combinations of features from a set of historical journal entries including transactions that are known to be approved and transactions that are known to be not approved;
wherein the machine learning model evaluates the combination of values from each input feature vector corresponding to a target journal entry from the set of journal entries based on at least the internalized patterns;
predict, by the machine learning model, whether the target journal entry is automatically approved for transfer to a general ledger database based on at least the combination of values from the corresponding input feature vector having a multi-dimensional similarity, within a threshold, to a pattern of values learned from the historical journal entries that were approved;
modify a status attribute in the target journal entry in the journal database to represent an approved status for each target journal entry that is predicted as automatically approved;
transfer the target journal entries having the approved status into the general ledger database; and
transfer the target journal entries that do not have the approved status to a workflow assigned to a user and generate an alert notification to the user to access the target journal entries in the workflow.

2. The computing system of claim 1, wherein the system is further configured to:
transfer the target journal entries having the approved status into a posting stage prior to transfer to the general ledger database.

3. The computing system of claim 1, wherein the system further includes:
a user interface configured to identify and display the plurality of attributes that are contained in the data structure of the set of journal entries; and
wherein the user interface is configured to allow a user to select one or more attributes from the plurality of attributes to use as features for training the machine learning model.

4. The computing system of claim 1, wherein the instructions to convert the set of journal entries into the set of feature vectors includes:
extracting a set of attributes from each individual journal entry and converting the set of attributes into a feature vector that represents the combination of values from the individual journal entry;
wherein the feature vectors converted from the set of journal entries have a standard format that is expected by the machine learning model.

5. The computing system of claim 1, further comprising:
an autoML system configured to automatically create, train, and test a plurality of machine learning models based on the set of historical journal entries; and
wherein the autoML system is configured to select one machine learning model from the plurality of machine learning models having an optimal accuracy for predicting automatically approved journal entries.

6. The computing system of claim 1, wherein the system is further configured to tune the machine learning model based on at least new feedback data for retraining the machine learning model with updated examples that include corrected outcomes for automatic approval of journal entries.

7. A non-transitory computer-readable medium that includes stored thereon computer-executable instructions that when executed by at least a processor of a computing system, wherein the computing system includes one or more computing devices, cause the computing system to:
train a machine learning model based on historical journal entries, wherein the machine learning model learns combinations of features from journal entries that were approved and journal entries that were not approved;
input a target set of journal entries into the machine learning model;
evaluate, by the machine learning model, individual journal entries from the target set of journal entries using extracted features from the individual journal entries;
predict, by the machine learning model, which of the individual journal entries qualify for automatic approval by identifying combinations of the extracted features from the individual journal entries that have a multi-dimensional similarity to the learned combinations of features that were previously approved from the historical journal entries; and
mark, by the machine learning model, the individual journal entries that are automatically approved with an automatically approved status.

8. The non-transitory computer-readable medium of claim 7,
wherein the machine learning model includes internalized patterns that are learned from the combinations of features from the historical journal entries; and
wherein the machine learning model is configured to evaluate the combinations of features from the individual journal entries from the target set of journal entries based on the internalized patterns in a multi-dimensional space to predict whether a given individual journal entry is automatically approved.

9. The non-transitory computer-readable medium of claim 7, wherein the machine learning model is trained with multi-dimensional combinations of features from the historical journal entries that represent transactions that are known to have been approved and transactions that are known to have been not approved;
wherein the multi-dimensional combinations of features form internalized patterns in a multi-dimensional space that are learned by the machine learning model from the multi-dimensional combinations of features;
wherein the internalized patterns are stored in a memory; and
wherein the machine learning model is configured to evaluate a target journal entry from the individual journal entries by at least:
extracting a plurality of features from the target journal entry to generate a feature vector; and
applying the feature vector in the internalized patterns stored in the memory.

10. The non-transitory computer-readable medium of claim 7, further comprising instructions for causing the processor to:
identify marked journal entries from the individual journal entries that are marked with the automatically approved status; and
transfer the marked journal entries having the automatically approved status from a journal data table into a general ledger database.

11. The non-transitory computer-readable medium of claim 7, wherein the prediction or determination may be performed within a confidence band where the highest confidence journal entries are automatically approved, while lower confidence journal entries are not automatically approved and recommended for manual review.

12. The non-transitory computer-readable medium of claim 7, further comprising instructions for causing the processor to:
prior to being evaluated by the machine learning model, convert the target set of journal entries into feature vectors having a standard format and data structure.

13. The non-transitory computer-readable medium of claim 7, further comprising instructions for causing the processor to:
tune the machine learning model based on at least new feedback data for retraining the machine learning model with updated examples that include corrected outcomes for automatic approval of journal entries.

14. A computer-implemented method, the method comprising:
accessing, via network communication, a set of journal entries from a journal database, wherein each journal entry is a data structure including a plurality of attributes associated with a transaction represented by the journal entry;
converting the set of journal entries into a set of feature vectors, wherein each feature vector corresponds to a given journal entry and includes a combination of values representing the transaction of the given journal entry;
executing a machine learning model that receives the set of feature vectors as input feature vectors, wherein the machine learning model is configured with internalized patterns in a multi-dimensional space that are learned from multi-dimensional combinations of features from a set of historical journal entries including transactions that are known to be approved and transactions that are known to be not approved;
evaluating, by the machine learning model, the combination of values from each input feature vector corresponding to a target journal entry from the set of journal entries based on at least the internalized patterns;
predicting, by the machine learning model, whether the target journal entry is automatically approved for transfer to a general ledger database based on at least the combination of values from the corresponding input feature vector having a multi-dimensional similarity, within a threshold, to a pattern of values learned from the historical journal entries that were approved;
modifying a status attribute in the target journal entry in the journal database to represent an approved status for each target journal entry that is predicted as automatically approved;
transferring the target journal entries having the approved status into the general ledger database; and
transferring the target journal entries that do not have the approved status to a workflow assigned to a user and generating an alert notification to the user to access the target journal entries in the workflow.

15. The method of claim 14, further comprising:
transferring the target journal entries having the approved status into a posting stage prior to transferring to the general ledger database, wherein the target journal entries are transferred from the posting stage to the general ledger database.

16. The method of claim 14, wherein the method further includes:
providing a user interface on a display, wherein the user interface identifies and displays the plurality of attributes that are contained in the data structure of the set of journal entries; and
providing selectable options, by the user interface, to allow a user to select one or more attributes from the plurality of attributes to use as features for training the machine learning model in a customized manner.

17. The method of claim 14, wherein converting the set of journal entries into the set of feature vectors includes:
extracting a set of attributes from each individual journal entry and converting the set of attributes into a feature vector that represents the combination of values from the individual journal entry; and
wherein the feature vectors converted from the set of journal entries have a standard format that is expected by the machine learning model.

18. The method of claim 14, further comprising:
training and testing a plurality of machine learning models to predict an automatically approved outcome for journal entries based on the set of historical journal entries; and
selecting one machine learning model from the plurality of machine learning models having an optimal accuracy for predicting the automatically approved outcome for the journal entries.

19. The method of claim 14, further comprising:
tune the machine learning model based on at least new feedback data for retraining the machine learning model with updated examples that include corrected outcomes for automatic approval of journal entries.

20. The method of claim 14, wherein converting the set of journal entries into the set of feature vectors includes converting the set of journal entries into the feature vectors having a standard format and standard data structure.
